(19) United States
(12) Patent Application Publication
(10) Pub. No.: US 2003/0065765 A1
(43) Pub. Date: Apr. 3, 2003

(54) Computer controlled display system for tracking the development of software products having a plurality of development lines through the monitoring of sequences of checkpoints respectively in said lines

(75) Inventors: Arnold Jeffery Daks, Round Rock, TX (US); David Bruce Kumhyr, Austin, TX (US); Erik Anthony Shelton, Austin, TX (US); Jacob Zachariah, Austin, TX (US)

Correspondence Address: Leslie A. Van Leeuwen, International Business Machines Corporation, Intellectual Property Law Dept., Internal Zip 4054, 11400 Burnet Road, Austin, TX, 78758, US

(73) Assignee: International Business Machines Corporation, Armonk, NY

(21) Appl. No.: 09/966,004

(22) Filed: Sep. 28, 2001

(51) Int. Cl. G06F 15/16; G06F 15/173; G09G 5/00

(52) U.S. Cl. 709/224; 709/202; 345/734

(57) ABSTRACT

A method and system for monitoring of the progress of product development distributed between a plurality of developmental lines in the development of complex computer software products so that the data relative to each of the lines are readily available and communicated to the developers working on the other lines. There is the combination of setting in each of the plurality of developmental lines, a sequence of checkpoints, tracking each of the developmental lines to determine the reached checkpoints and displaying the plurality of developmental lines and indicating said reached checkpoints. Responsive to an interactive user selection, the invention further provides an implementation for modifying the developmental lines and the checkpoints, and for displaying said modifications. In this connection, an implementation for displaying at each of said checkpoints a set of developmental attributes for said checkpoint is provided.

### CROSS-REFERENCE TO RELATED COPENDING PATENT APPLICATIONS

The following patent application, which is assigned to the assignee of the present invention and filed concurrently herewith, covers subject matter related to the subject matter of the present invention: A COMPUTER CONTROLLED DISPLAY SYSTEM FOR CONTROLLING AND TRACKING OF SOFTWARE PROGRAM OBJECTS THROUGH A DISPLAYED SEQUENCE OF BUILD EVENTS AND ENABLING USER REGISTRATION TO PERFORM ACTIONS ON SAID BUILD EVENTS, David Bruce Kumhyr et al. (Attorney Docket No. AUS9-2001-0766).

### TECHNICAL FIELD

The present invention relates to distributed programming for computer software product development and particularly to the monitoring of the progress of product development distributed between a plurality of developmental lines in the development of complex computer software products.

### BACKGROUND OF RELATED ART

The last decade has been marked by a technological revolution driven by the convergence of the data processing and consumer electronics industries together with the explosion of the World Wide Web (Web) or Internet. As a result, extraordinary worldwide communication channels and resources have become available to businesses, and this has forever changed how many businesses and industries develop products, as well as the time cycles of such product development.

Nowhere are these dramatic changes in product development more apparent than in the development, testing and eventual production of computer software products. Over its first forty years, prior to the 1980's, the software development environment was one in which an individual or a small dedicated group willing to put in long hard hours could create “elegant” software or “killer applications” directed to and effective in one or more of the limited computer system environments existing at the time.

Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not be incompatible with, each newly developed computer software product, the development cycles have become very complex. Even when the software product development is an upgrade of an existing product, every addition, subtraction or modification of the program could have an insignificant or a profound effect on another operating system or application program which must be supported.

During the evolution of the software industries over the past two decades it has been evident that developing software will be combined in new often unforeseen ways, and, thus, there is an increased likelihood that the individual developments will drive system programs that must be supported into inoperable states for certain purposes or under certain conditions. This changed development environment has caused many traditional and responsible software development houses to take the time and make the effort to resolve all potential incompatibilities with all existing and standard software before the new developed software products were commercially released. Unfortunately, the computer industry landscape is littered with the “corpses” of such responsible longer development cycle software houses that lost out to newer software product entrepreneurs that rushed to the market with unresolved incompatibilities. This in turn led to a distrust of new software products by consumers and businesses, i.e. a new software product will lead to down time until incompatibilities are resolved.

Accordingly, the computer software development industries have been working over the past several years toward the goal of the shortest development cycles with the fewest incompatibilities with standard existing software. One widely used approach to shortening software development cycle times has been to break down or distribute the development of complex software products into a plurality of development lines. Many of these developmental lines or portions of such lines are used to insure the compatibility of the software under development with existing products respectively associated with the developmental lines.

### SUMMARY OF THE PRESENT INVENTION

The present invention provides a method and system for monitoring of the progress of product development distributed between a plurality of developmental lines in the development of complex computer software products so that the data relative to each line is readily available and communicated to the developers working on the other lines. The present invention involves the combination of means for setting in each of the plurality of developmental lines, a sequence of checkpoints, means for tracking each of the developmental lines to determine the reached checkpoints, means for displaying said plurality of developmental lines and indicating said reached checkpoints. Responsive to an interactive user selection, the invention further provides means for modifying the developmental lines and the checkpoints, and means for displaying said modifications. In this connection, means for displaying at each of said checkpoints a set of developmental attributes for said checkpoint are provided. Also, there is optionally provided means for modifying the developmental attributes for each of said checkpoints, together with means for displaying the modifications at each of said checkpoints. These developmental attributes which are modified include actions performed in said software product development. In such modifications, the actions may be switched from one developmental line to another.

In an embodiment of the invention, the means for tracking are remote from said means for displaying, and the system further includes means for storing, in association with the means for displaying, the data tracked by the means for tracking, and means for communicating the data tracked to the means for storing.

The invention is particularly effective during the last stages in the building of software products when the software components developed along each of the discrete developmental lines that have been functionally implemented are finally integrated and are ready for use as the complete program products. In this integration, it is important that the components developed along the individual lines are compatible with each other. Such integration of individual lines is often provided for after a functional implementation of the program product has evolved. The arrangement of the present invention permits the owners of and/or the users with responsibilities in the integration of the developmental lines to better comprehend what is going on with respect to the other lines.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic general view of a network of a plurality of computer stations, each for monitoring a developmental product line;

FIG. 2 is a block diagram of a data processing system including a central processing unit and network connections via a communications adapter which is capable of functioning as one of the display stations or the network server of FIG. 1;

FIG. 3 is a diagrammatic view of a display screen on a computer station monitoring a developmental line showing the initial status of the plurality of developmental lines;

FIG. 4 is the view of FIG. 3 after the development of product along the developmental lines has progressed with many checkpoints having been reached but experiencing a failure at a checkpoint on one of the lines;

FIG. 5 is the view of FIG. 4 after the user has requested details of the checkpoint failure, been advised of the failed attribute and offered a menu of possible solutions;

FIG. 6 is the view of FIG. 5 after the user has selected a solution to the checkpoint failure of FIG. 5;

FIG. 7 is a portion of the view of FIG. 6 after an authorized user has requested to be enabled to modify attributes of one of the developmental lines at another checkpoint;

FIG. 8 is the view of FIG. 7, after an unauthorized user has requested to be enabled to modify attributes of one the developmental lines at another checkpoint and has been refused modification access;

FIG. 9 is an illustrative flowchart describing the setting up of the process of the present invention for the monitoring of a plurality of developmental lines in a complex product development; and

FIG. 10 is a flowchart of an illustrative run of the process setup in FIG. 9.

### DETAILED DESCRIPTION OF THE PREFERRED EMBODIMENT

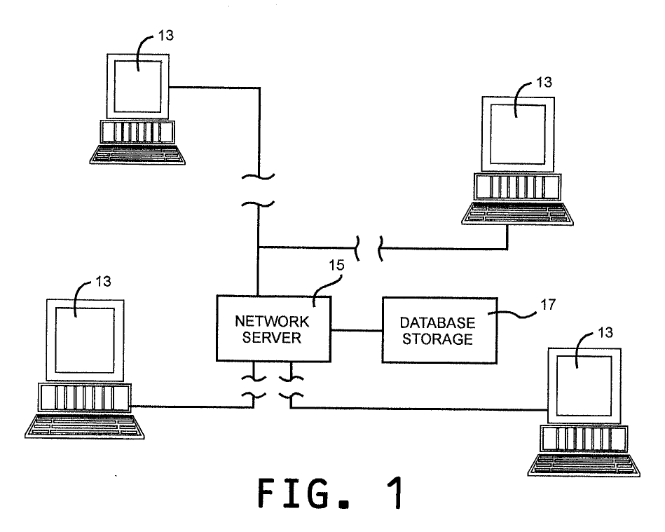

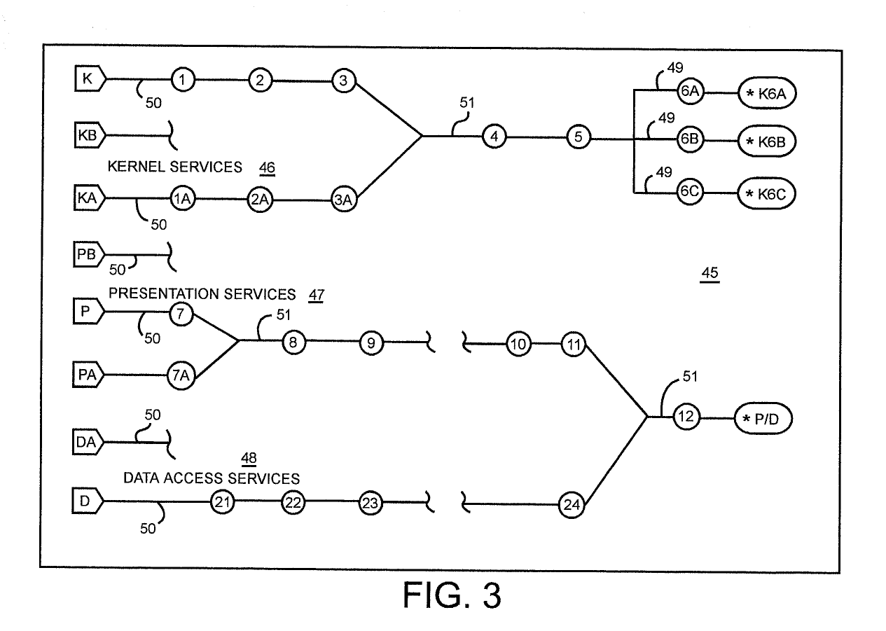

Referring to FIG. 1, a plurality of computer controlled display stations 13 are shown connected in a network arrangement via network server 15. Stations 13 are representative of display terminals, with each respective terminal associated with one of the plurality of developmental lines for producing the overall software product. A representative display of the tracking display shown at display stations 13 is displayed in FIG. 3, which will be subsequently described in greater detail. The tracked data to support the displays at stations 13 is stored in database storage 17. Dependent upon the extent of the distribution of the ultimate software product into local and/or remote developmental lines, the network of FIG. 1 may be a local area network (LAN) or a wide area network (WAN), including, of course, the Web.

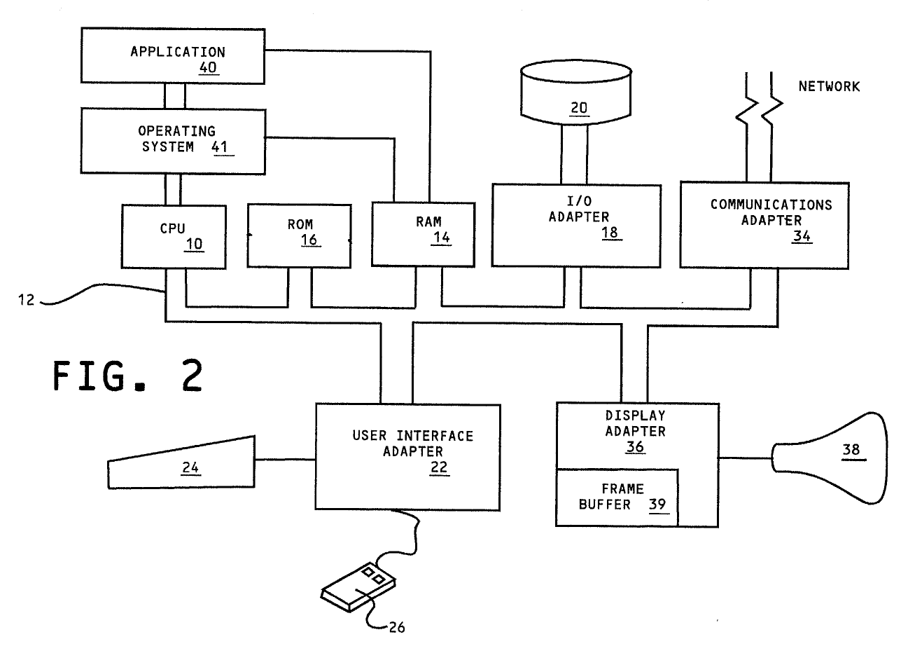

Before FIGS. 3 through 8, related to the overall tracking of the developmental lines, are described in detail, reference is made to FIG. 2 which represents a typical data processing terminal that may function as the computer controlled display stations for tracking the progress on the developmental lines. This typical data processing terminal may be used as the network server shown in FIG. 1. A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. operating system 41 may be one of the commercially available operating systems such as the AIX operating system available from IBM; Microsoft's WindowsMe™ or Windows 2000™, as well as various other UNIX and Linux operating systems. Application programs 40, controlled by the system, are moved into and out of the main memory Random Access Memory (RAM) 14. These programs include the programs of the present invention for the tracking of work progress on the various product developmental lines to be described hereinafter in greater detail with respect to FIGS. 3 through 8. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over a LAN or a WAN, which includes, of course, the Web or Internet. The latter will provide a primary communication means through which the tracked data that is to be dynamically displayed on display stations 13 in FIG. 1 will be transmitted and stored in database 17. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Referring now to FIG. 3, there is shown a diagrammatic view of a display screen on a computer station monitoring a developmental line showing the initial status of the plurality of developmental lines. The present invention relates to monitoring of the progress of product development distributed between a plurality of developmental lines in the development of complex computer software products so that the data relative to each of the lines are readily available and communicated to the developers working on the other lines. Thus, the display screen of FIG. 3 is available at display monitoring stations associated with each developmental line, as well as at various display stations accessed by the owners of the various software product builds provided by the developmental lines.

It should be understood that in the illustrations to be described with respect to FIGS. 3 through 8, there will be no attempt made to relate the software build processes illustrated to any real software products. Rather, the illustrations will be given primarily to illustrate how the monitoring and coordinating tools offered by the invention may be applied at various stages in any complex software product build process in tracking and displaying the progress of the build processes along the respective developmental lines.

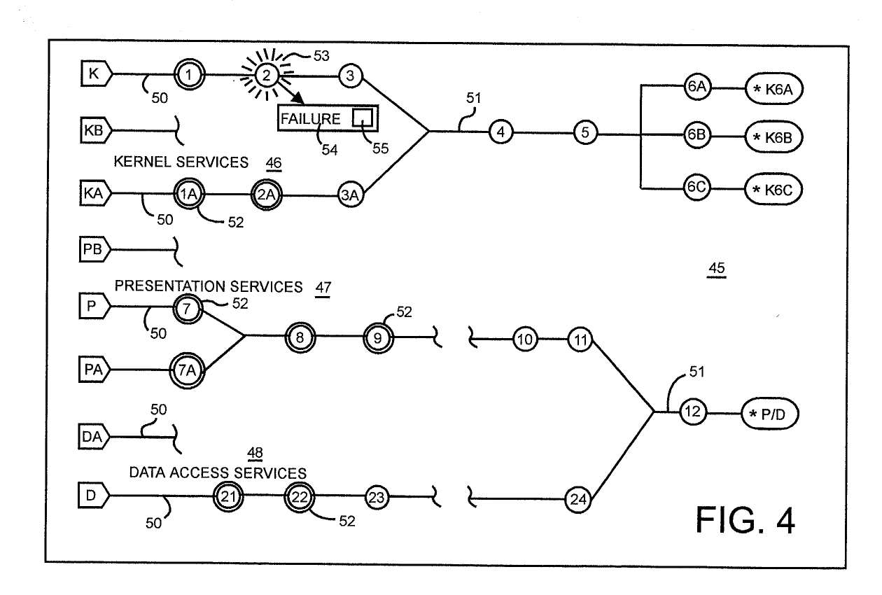

Thus, with respect to FIG. 3, the software product tracking display is shown at an initial stage. For convenience in illustration, only a fragmentary portion of the developmental lines for a particular product are shown. Several developmental lines 51 are shown: K, KA and KB group of Kernel Services 46; PB, P and PA of Presentation Services 47; and DA and D of Data Access Services 48. Some of the individual developmental lines 50 may merge at various points into combined lines 51 where there is common processing of the software being developed, or the combined lines 51 may again be separated into individual lines 49 where processing along individual lines is again called for. The processing will continue until the software builds of each group of developmental lines is completed: *K6A, *K6B, *K6C and *P/D. The lines have individual checkpoints: 1-5; 1A-3A; 6A-6C; 7A; 7-12; and 21-24, which the system will track. Since the operations are at an initial stage, none of these checkpoints have been completed. FIG. 4 shows the monitoring system at a later stage. Several checkpoints have been reached: 1, 2A, 7A, 7-9, 21 and 22. These should be indicated in any convenient manner intuitive to the user. In the present case, the checkpoint is indicated by a double circle.

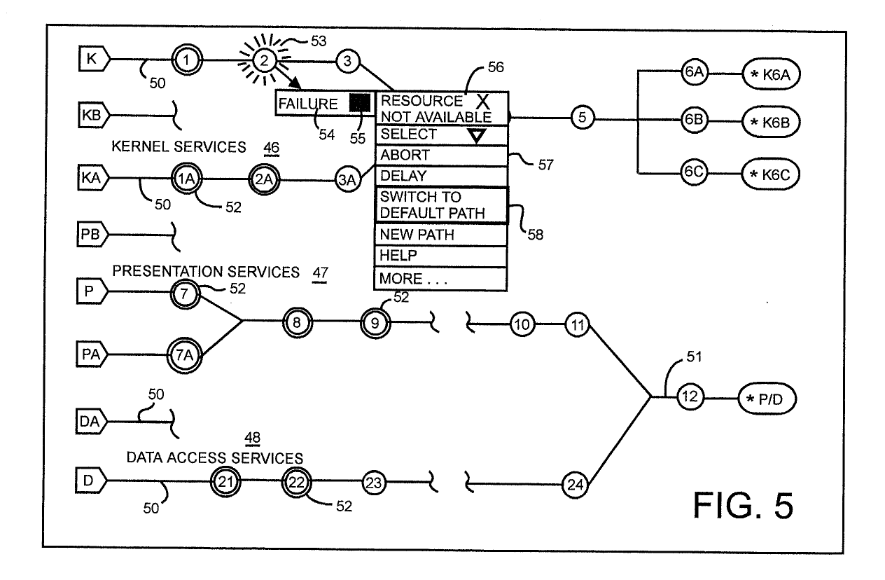

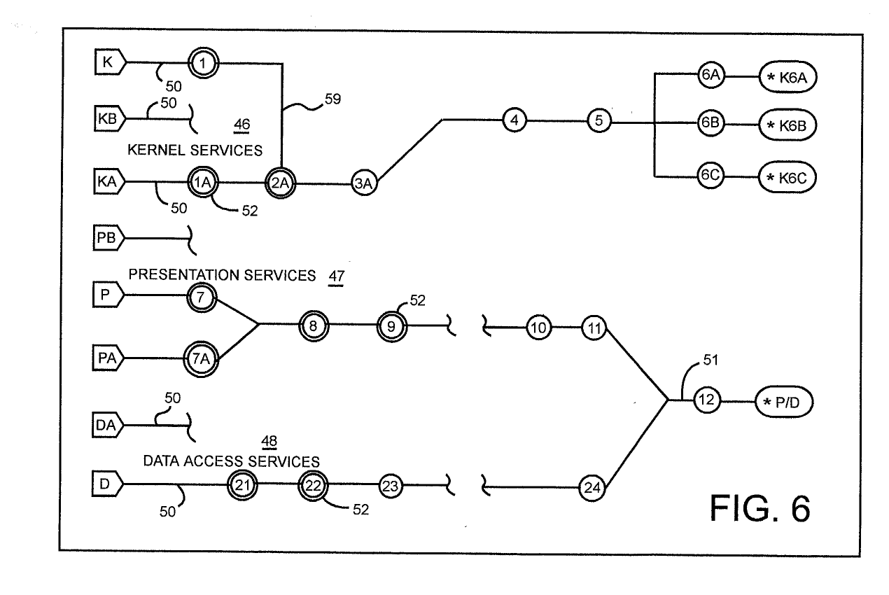

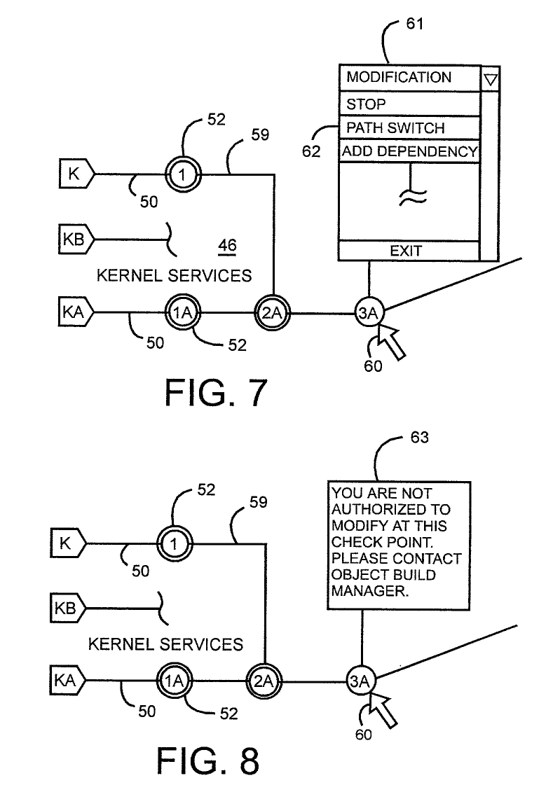

Let us now consider how a system of this invention could handle a failure condition. It is indicated by the flashing 53 of checkpoint 2 and the display of Failure flag 54 that there has been a failure that prevents checkpoint 2 from being completed. To get an explanation or annotation of the failure condition at checkpoint 2, the user clicks on, i.e. selects, button 55. The explanation 56, as shown in FIG. 5, is “Resource X Not available” on the developmental line at checkpoint 2. A selectable menu 57 is made available to the user from which the user has selected and authorized action 58: “Switch to Default Path”. It should be noted that menu 57 will be made available only to users whose ID is authorized to take action to modify problems at particular checkpoints. Thus, there may be several levels of authorization available to specific users to access information or take actions at checkpoint 2. For example, one specific user may only be authorized to view the display screen of FIG. 4. A user authorized at another level may only be able to access explanation 56 of the failure but not authorized to take any action to solve the condition. Finally, as in the present illustration, the user may be authorized to take actions. Thus, selection 58 switches, as shown in FIG. 6, to the default alternate path 59 that shifts the development line through checkpoint 2A. It should be noted that there may be other levels of authorization, e.g. the user may desire to take an action at a checkpoint that has not encountered a problem. As shown in FIG. 7, which is an enlarged partial view of FIG. 6, a user has requested to take an action with respect to checkpoint 3A. In this case, the user is authorized to take actions to modify. He is presented with displayed modification menu 61 from which he may select an appropriate item 62. On the other hand, if the user is unauthorized to make modifications, window 63 appears which advises the user that he is unauthorized to make changes at this checkpoint and he is advised to contact the particular object build manager owning the development line at that particular checkpoint.

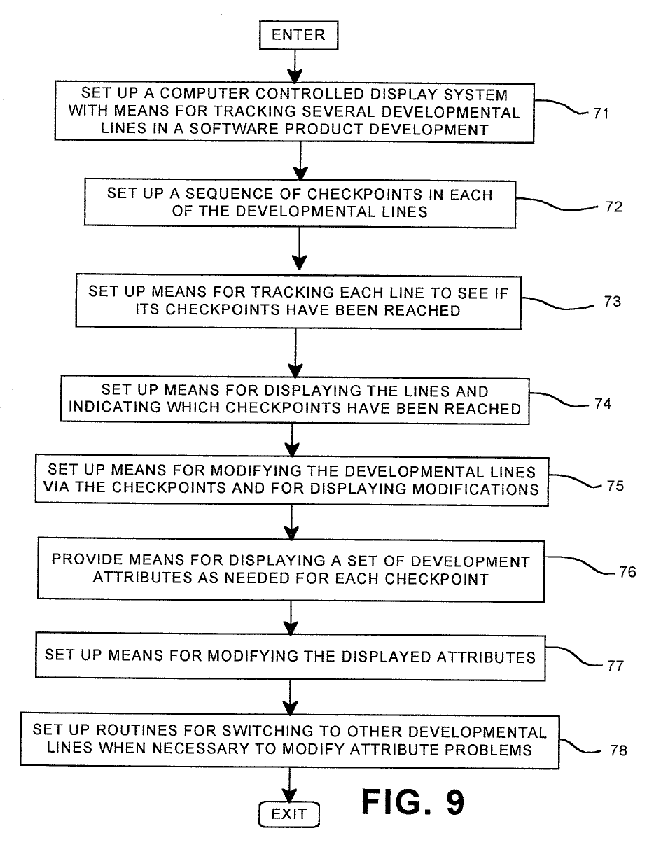

Now, with reference to FIG. 9, we will describe the setting up or development of a program according to the present invention for the tracking of work progress on the various product developmental lines. There is set up a computer controlled display system with means for tracking several development lines in a software product development, step 71. There is set up a sequence of checkpoints in each of the developmental lines, step 72. Means for tracking each of the lines to see if its checkpoints have been reached is also set up, step 73. Means for displaying the developmental lines and indicating which checkpoints have been reached is also set up, step 74. Means for modifying the developmental lines at their checkpoints and for displaying modifications is also set up. There is set up a means for displaying sets of developmental attributes as requested and needed for each checkpoint, step 76. Means for modifying the displayed attributes of step 76 is also set up, step 77, and routines are set up for switching to other developmental paths or lines whenever necessary to modify attribute problems, step 78.

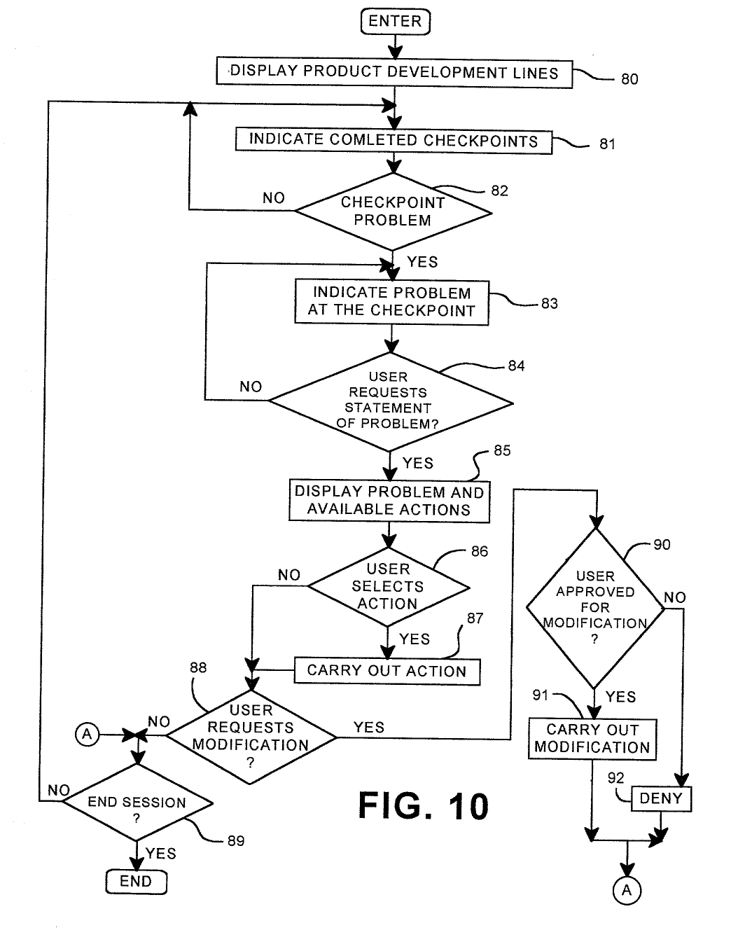

Now that the basic program set up has been described, there will be described with respect to FIG. 10 a flowchart of a simple operation showing how the program could be run. The display of FIG. 3 showing the developmental lines being monitored is displayed at the previously described display stations or terminals, step 80. The completed checkpoints are indicated, step 81. A determination is made as to whether there is a problem at any checkpoint, step 82. If No, the process continues to be monitored with indicated checkpoints, step 81. If the decision from step 82 is Yes, there is a problem, then, step 83, the problem or failure is indicated adjacent to the checkpoint. A determination is then made, step 84, as to whether the user has requested a statement of the problem. If No, then the process may return to step 83 where the problem continues to be indicated. If the decision from step 84 is Yes, the user has requested a statement of the problem, the problem and available actions are displayed, step 85. (We are assuming that the user is authorized to address the problem.) Then, step 86, a determination is made as to whether the user has selected to take an action to correct the problem. If Yes, step 87, the action is carried out. At this point, as well as in the case where the user has chosen not to select an action, No, step 86, it may be convenient to illustrate a situation where the user, even in a situation where there are no apparent problems with checkpoints, may request to make a modification: a determination is made, step 88, as to whether the user has requested a modification. If Yes, a further determination is made, step 90, as to whether the user is authorized to make the modification. If No, the request is denied, step 92. If Yes, the modification is carried out, step 91. Now, if the decision from step 88 had been No, or after either step 91 or 92 via branch “A”, a determination may conveniently be made, step 89, as to whether the display session is at an end. If Yes, it is exited. If No, the process is returned to step 81 where the display with its currently completed checkpoints is displayed.

One of the preferred implementations of the present invention is in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled display system for tracking the development of complex software products having a plurality of developmental lines comprising:
means for setting in each of said plurality of developmental lines, a sequence of checkpoints;
means for tracking each of said developmental lines to determine the reached checkpoints; and
means for displaying said plurality of developmental lines and indicating said reached checkpoints.

2. The computer controlled display system of claim 1 further including:
means for modifying said developmental lines and said checkpoints; and
means for displaying said modifications.

3. The computer controlled display system of claim 2 further including means for displaying at each of said checkpoints, a set of developmental attributes for said checkpoint.

4. The computer controlled display system of claim 3 further including:
means for modifying said developmental attributes for each of said checkpoints; and
means for displaying said modifications at each of said checkpoints.

5. The computer controlled display system of claim 3 wherein said developmental attributes include actions performed in said software product development.

6. The computer controlled display system of claim 5 wherein said means for modifying said actions switch said actions to other of said developmental lines.

7. The computer controlled display system of claim 2 wherein:
said means for tracking are remote from said means for displaying,
and said system further includes:
means for storing, in association with said means for displaying, the data tracked by said means for tracking; and
means for communicating the data tracked to said means for storing.

8. A method for tracking the development of complex software products having a plurality of developmental lines on a computer controlled display comprising:
setting in each of said plurality of developmental lines, a sequence of checkpoints;
tracking each of said developmental lines to determine the reached checkpoints; and
displaying said plurality of developmental lines and indicating said reached checkpoints.

9. The method for tracking of claim 8 further including the steps of:
modifying said developmental lines and said checkpoints; and
displaying said modifications.

10. The method for tracking of claim 9 further including the step of displaying at each of said checkpoints, a set of developmental attributes for said checkpoint.

11. The method for tracking of claim 10 further including the steps of:
modifying said developmental attributes of a plurality of said checkpoints; and
displaying said modifications at each of said modified checkpoints.

12. The method for tracking of claim 10 wherein said developmental attributes include actions performed in said software product development.

13. The method for tracking of claim 12 wherein said step of modifying said actions switches said actions to other of said developmental lines.

14. The method for tracking of claim 9 wherein:
said step of tracking is carried out remote from said displaying step,
and further including the steps of:
storing, in association with said displaying step, the data tracked in said tracking step; and
communicating the data tracked to said storing step.

15. A computer program having code recorded on a computer readable medium for tracking, on a computer controlled display, the development of complex software products having a plurality of developmental lines comprising:
means for setting in each of said plurality of developmental lines, a sequence of checkpoints;
means for tracking each of said developmental lines to determine the reached checkpoints; and
means for displaying said plurality of developmental lines and indicating said reached checkpoints.

16. The computer program of claim 15 further including:
means for modifying said developmental lines and said checkpoints; and
means for displaying said modifications.

17. The computer program of claim 16 further including means for displaying at each of said checkpoints, a set of developmental attributes for said checkpoint.

18. The computer program of claim 17 further including:
means for modifying said developmental attributes for each of said checkpoints; and
means for displaying said modifications at each of said checkpoints.

19. The computer program of claim 17 wherein said developmental attributes include actions performed in said software product development.

20. The computer program of claim 19 wherein said means for modifying said actions switch said actions to other of said developmental lines.

21. The computer program of claim 16 wherein:
said means for tracking are remote from said means for displaying,
and said system further includes:
means for storing, in association with said means for displaying, the data tracked by said means for tracking; and
means for communicating the data tracked to said means for storing.

22. A computer controlled display system for tracking the building of a program product from a functional implementation stage to a complete integrated program product comprising:
a plurality of developmental lines respectively corresponding to each of a plurality of program components to be integrated into said complete program product;
means for setting in each of said plurality of developmental lines, a sequence of checkpoints;
means for tracking each of said developmental lines to determine the reached checkpoints; and
means for displaying said plurality of developmental lines and indicating said reached checkpoints.

23. The computer controlled display system of claim 22 further including means for displaying at each of said checkpoints, a set of attributes for said checkpoint related to the compatibility functions of said checkpoint line.

24. The computer controlled display system of claim 23 further including:
means for modifying said attributes for each of said checkpoints; and
means for displaying said modifications at each of said checkpoints.

25. A method for tracking, on a computer controlled display, the building of a program product from a functional implementation stage to a complete integrated program product comprising:
setting up a plurality of developmental lines respectively corresponding to each of a plurality of program components to be integrated into said complete program product;
setting up in each of said plurality of developmental lines, a sequence of checkpoints;
tracking each of said developmental lines to determine the reached checkpoints; and
displaying said plurality of developmental lines and indicating said reached checkpoints.

26. The method for tracking of claim 25 further including the step of displaying at each of said checkpoints, a set of attributes for said checkpoint related to the compatibility functions of said checkpoint line.

27. The method for tracking of claim 26 further including the steps of:
modifying said attributes for each of said checkpoints; and
displaying said modifications at each of said checkpoints.

28. A computer program having code recorded on a computer readable medium for tracking, on a computer controlled display, the building of a program product from a functional implementation stage to a complete integrated program product comprising:
means for tracking a plurality of developmental lines respectively corresponding to each of a plurality of program components to be integrated into said complete program product;
means for setting in each of said plurality of developmental lines, a sequence of checkpoints;
means for determining the reached checkpoints in each of said plurality of developmental lines; and
means for displaying said plurality of developmental lines and indicating said reached checkpoints.

29. The computer program of claim 28 further including means for displaying at each of said checkpoints, a set of attributes for said checkpoint related to the compatibility functions of said checkpoint line.

30. The computer program of claim 29 further including:
means for modifying said attributes for each of said checkpoints; and
means for displaying said modifications at each of said checkpoints.
